(19) United States
(12) Patent Application Publication
(10) Pub. No.: US 2004/0044545 A1
(43) Pub. Date: Mar. 4, 2004

(54) Home care monitor systems

(76) Inventors: William P. Wiesmann, Washington, DC (US); Adrian R. Urias, Germantown, MD (US); Loland Alex Pranger, Montgomery Village, MD (US); Ronalee Lo, Los Angeles, CA (US)

Correspondence Address: Abanti B. Singla, Esq., Bartunek & Bhattacharyya, Ltd., Suite 405, 10420 Little Patuxent Parkway, Columbia, MD, 21044, US

(21) Appl. No.: 10/229,958

(22) Filed: Aug. 28, 2002

(51) Int. Cl. G06F 17/60

(52) U.S. Cl. 705/2

(57) ABSTRACT

Home care monitor systems are used to monitor physiological parameters of a user who is remotely located from a health care provider. The measured physiological parameters can be transmitted via telephone lines or a modem to a server component, which provides a queries database and a measurement database for storing the measured physiological parameters and generating queries to the user based on the measurements. The response to the queries, the measured physiological parameters and other data can be accessed by and transmitted to a remote health care provider to ascertain the health of the user.

### BACKGROUND OF THE INVENTION

Home care monitor systems have improved the quality of life of many home-based patients, by allowing them in home monitoring of vital signs and other physiological parameters. In addition, these systems have allowed for better efficiency on the part of health-care providers since these parameters can be transmitted to remote locations such as doctors' offices, hospitals, pharmacists and other health care professionals to provide them with accurate readings for efficient evaluation and diagnosis, without the patient being physically present.

Typically, physical parameters are measured by sensors such as blood pressure gauges, pulse oximetry sensors, etc. The data obtained from these sensors are transferred to a computer and further transmitted to a remote location via a modem, the Internet, telephone lines or the like. In addition, some existing home care systems include medicine dispensers that are utilized in combination with the home care systems.

Home care systems generally require the patients to subject themselves to some type of a cuff, sleeve, sensor pad or invasive sampling, through which the sensor takes a reading. Once activated, the sensor automatically measures the reading, stores it and then transmits it to a remote location. Prior art systems are discussed below.

U.S. Pat. No. 6,050,940 to Braun, et al., discloses a portable physiological unit that is capable of being plugged into several sensors. The collected data is configured so that it is capable of being transmitted over the Internet.

U.S. Pat. No. 6,171,264 to Bader discloses a portable physiologic data collection and analysis apparatus that transmits collected information to a computer, and thereafter transmits the stored information to a remote location. The device can be used for analog and digital signals and includes a memory for storing data and a transmitter system for transmitting the data over a wireless modem or other interface.

U.S. Pat. No. 5,935,060 to Illif, et al., discloses a system and method that allows for computer-based diagnostics of medical conditions. The system provides for a series of queries that generate diagnostic scripts that can be used by a remote health care professional to diagnose a patient's symptoms.

U.S. Pat. No. 5,842,975 to Illyes, et al., discloses an apparatus for measuring physiological parameters including blood pressure, a microcontroller for beginning and ending measurements, a display feature and a connector for sending the information to a remote location.

U.S. Pat. No. 6,221,010 to Lucas, U.S. Pat. No. 6,102,855 to Kehr, et al., U.S. Pat. No. 4,933,873 to Kaufman, et al., all disclose a home medical care system having a medication dispensing system.

While prior art home care monitor systems are capable of obtaining medical information or providing a medicine dispensing system, none of the systems provide for a single device which is capable of operating as a multifunctional monitoring and medicine administering system, whereby the patient/user is also capable of providing additional information in the form of queries/answers, to customize patient treatment and provide greater accuracy in treatment.

### SUMMARY OF THE INVENTION

It is therefore the objective of this invention to provide a home care monitoring system that is capable of being customized to suit the individual needs of each home-based patient.

It is also an objective of this invention to provide a home care system that monitors physiological parameters and stores the information for remote or future retrieval.

It is also an objective of this invention to provide a home care system that can provide queries to a patient to better diagnose symptoms, better evaluate physiological data and answer patient questions, so that each patient receives individual attention.

These and other objectives of the present invention provide for a home care system that is efficient and functional, and provides greater accuracy.

### DESCRIPTION OF THE DRAWINGS

FIG. 1 is a schematic of the home unit, the server and the devices of the present invention.

FIG. 2 is a schematic of the home unit of the present invention.

FIG. 3 is a schematic of the home unit and the server of the present invention.

### DETAILED DESCRIPTION OF THE EMBODIMENTS

The present invention is directed to a home care monitoring system that is capable of providing home-based monitoring of physiological conditions and also capable of storing and transmitting the obtained physiological information to a remote location. The home care monitoring system of the present invention allows a physician or medical caregiver to remotely monitor a home-based patient/user, thereby providing rapid and efficient health care to a home-based patient/user in emergency and non-emergency conditions.

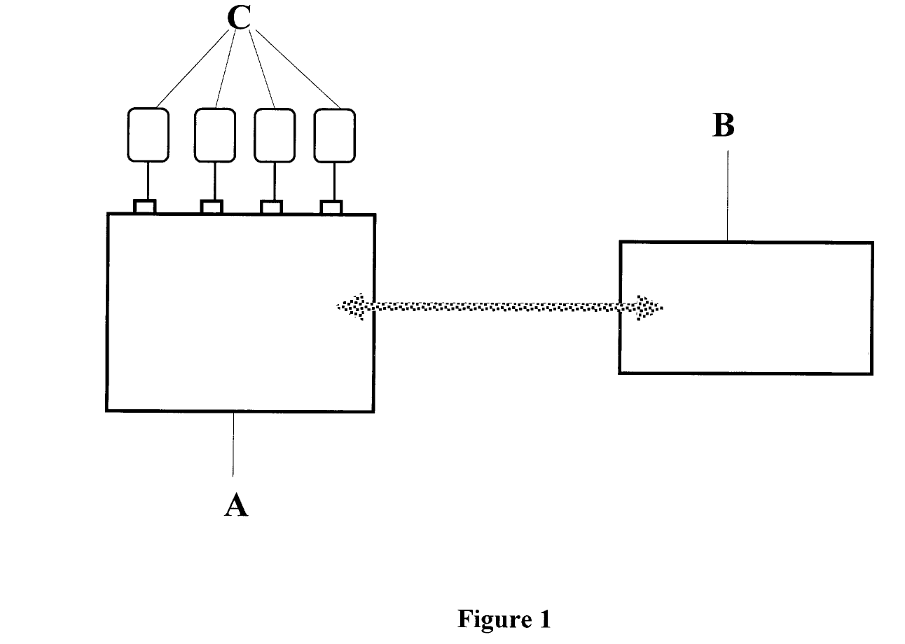

As shown in FIG. 1, the system S of the present invention includes a home component/unit A, at least one server component B and a plurality of devices C. Devices C are used to measure a variety of medical responses as well as obtain non-medical information such as the user's identity. Devices C include, but are not limited to, blood pressure sensors, glucometers, pulse oximeters, scales, medicine prompting systems, printers and identifier apparatus such as bar code readers, etc.

Home Unit A:

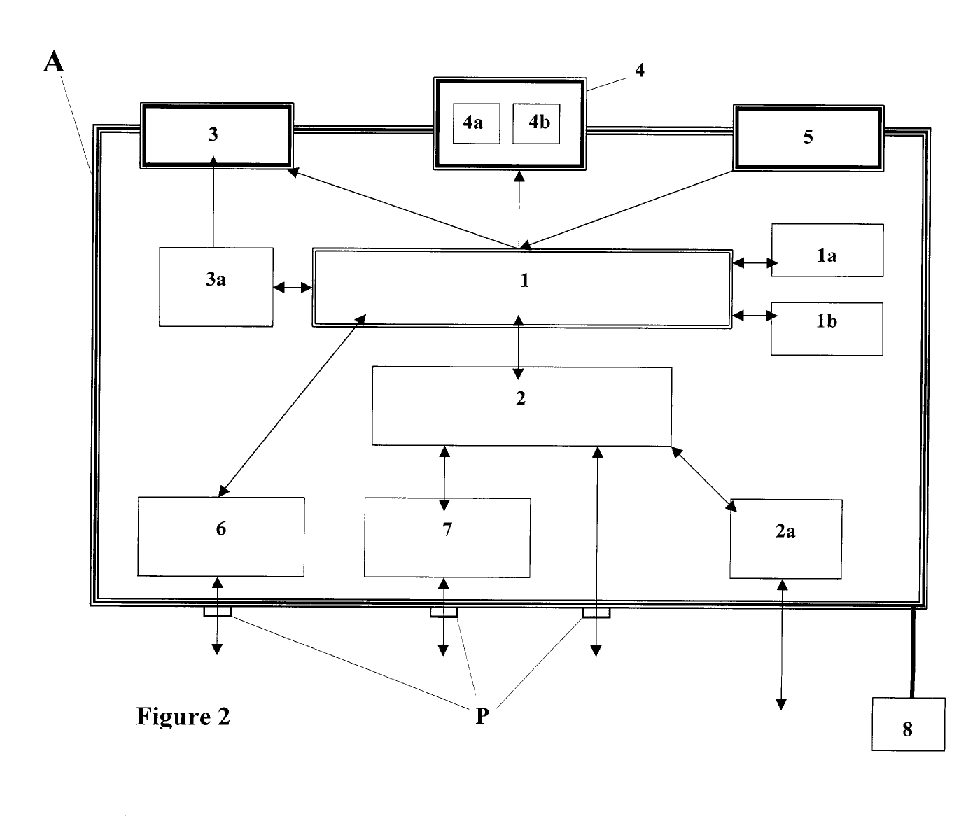

As shown in FIG. 2, the home unit A houses several components including a microprocessor 1. Microprocessor 1 is connected to at least one memory component 1a that stores data. The memory component 1a includes but is not limited to Random Access Memory (RAM), Static Random Access Memory (SRAM), Flash Memory, and Electrically Erasable Programmable Read Only Memory (EEPROM) type devices.

Microprocessor 1 is also connected to a real-time clock 1b that keeps track of the date and time and imprints a timestamp on incoming and outgoing data. The real-time clock 1b will also be connected to the server component B so that the time and date on the real-time clock 1b and server B are synchronous.

Microprocessor 1 is also connected to a multi-channel communications component 2 that is used to receive and transmit information from a source external to unit A. Multi-channel communications component 2 can transmit information serially, via radio frequency, or through wireless systems known in the art and compatible with the home care monitoring system of the present invention. Multi-channel communications component 2 is also connected to a modem/Ethernet component 2a for transmitting/receiving information via computers.

Microprocessor 1 is further connected to an audio output section 3. Audio output section 3 provides voice commands, queries and/or aural cues to the user. Voice/prerecorded audio data generator 3a is used to provide particular voice signals to the audio output section 3. These voice signals are stored in memory component 1a and can take the form of a physician, health care giver, a family member's voice or a computer generated voice signal.

A visual output 4 is also connected to microprocessor 1. The visual output 4 includes a display screen 4a. The display screen 4a is used to display a plurality of screens that provide the user with a variety of necessary information, as well as query sets that obtain information from the user. Display screen 4a can display text or graphics. In an alternate embodiment, visual output 4 can also include a touch screen 4b so that the user can input information or respond to query sets by directly touching the appropriate response sections of the touch screen 4b. Note that the queries or information can be available to the user through the audio output section 3 and/or through the display screen 4a.

In an alternate embodiment, user input system 5, also connected to the microprocessor 1, can be used by the user to input information or query responses. The user input system 5 allows the user to submit information or answer questions posed via the audio output 3 and/or the visual output 4. User input system 5 can be touch-screen displays, keypads, buttons and switches.

As described above, devices C are in actuality a plurality of individual devices capable of obtaining a wide range of data. The number and type of devices utilized by a home unit A are determined according to design and use requirements. Each home unit A includes a plurality of ports P through which each of the devices C are connected to home unit A. The ports P are capable of hosting multiple devices having unique signal configurations and voltages.

Additionally, devices C can be synchronized with the real-time clock 1b so that, if devices C are capable of imprinting a timestamp on data, there will be uniformity of time and date.

Since devices C can be digital, analog or have varying voltage levels, home unit A includes an analog/digital converter 6 and a voltage level converter 7, both of which are connected to microprocessor 1.

Home unit A also includes a power source port 8 that allows home component/unit A to operate using AC/DC power and/or battery power.

In use, home unit A collects data using the various devices C. The unit A is turned on and the audio output section 3, and/or the visual output 4 provides introductory information on the system A. Thereafter, display screen 4a provides a plurality of “screens” on how to operate home unit A, which devices C to use and how to input the appropriate information. Note that touch screen 4b and keypad 5 both include commands such as “help/info,” “yes/go” and “no/stop” functions to aid the user.

### EXAMPLE 1

An example of the manner by which home unit A is operated using a variety of “screens,” is given below:

Screen A and B are discussed. In this example, screen A corresponds to a blood pressure measurement obtained from a blood pressure device, while screen B corresponds to a blood glucose measurement obtained from a blood glucose device:

```
Button Labels
“Help/System Info” (Previously ‘A’)
“Yes/Continue” (Previously ‘B’)
“No/Cancel” (Previously ‘C’)
Screen 1
-------------------
    Trex/Sekos
  Home Care Monitor
  Press a button
--------------------
ACTION −> RESULT
Press A −> Screen 21 (system info screens)
Press B −> Screen 2
Press C −> Screen 2
BP Measurement −> Screen 3
Gluc Measurement −> Screen 4
3 minutes elapsed −> Screen 1
Screen 2
---------------------
Please take or send
your blood pressure
or blood glucose
measurements.
---------------------
ACTION −> RESULT
Press A −> Screen 5 (Walk thru BP measurement process)
Press B −> Screen 2
Press C −> Screen 1
BP Measurement −> Screen 3 (ask for gluc)
Gluc Measurement −> Screen 4 (ask for BP)
3 minutes elapsed −> Screen 1
Screen 3
---------------------
Your blood pressure
measurement was
received. Now turn
on your glucometer.
---------------------
ACTION −> RESULT
Press A −> Screen 7 (ask if blood glucose measurement taken)
Press B −> Screen 7
Press C −> Screen 18 (ask if just want to send BP)
BP Measurement −> Screen 3
Gluc Measurement −> Screen 9 (send data)
3 minutes elapsed −> Screen 6
Screen 4
---------------------
Your blood glucose
measurement was
received. Now take
your blood pressure.
---------------------
ACTION −> RESULT
Press A −> Screen 5 (walk thru blood pressure measurement)
Press B −> Screen 5
Press C −> Screen 8 (ask if just want to send BG)
BP Measurement −> Screen 9 (send data)
Gluc Measurement −> Screen 4
3 minutes elapsed −> Screen 6
Screen 5
---------------------
Place cuff around
your upper arm and
press blue button to
take a measurement.
---------------------
ACTION −> RESULT
Press A −> Screen 10 (is cable connected to HCM?)
Press B −> Screen 10 (is cable connected to HCM?)
Press C −> IF BG measurement already taken: Screen 8 (ask if just want
to send BG)
```

Otherwise: Screen 2

BP Measurement −> IF BG measurement already taken: Screen 9
(send data)

Otherwise: Screen 3

Gluc Measurement −> Screen 4
3 minutes elapsed −> Screen 10
Screen 6
---------------------
Do you need more
time?
---------------------
ACTION −> RESULT
Press A −> act as if help (‘A’) was pressed on previous screen
Press B −> Previous screen
Press C −> Act as if ‘C’ was pressed on previous screen
BP Measurement −> IF BG measurement already taken: Screen 9
(send data)

Otherwise: Screen 3

Gluc Measurement −> IF BP measurement already taken: Screen 9

Otherwise: Screen 4

3 minutes elapsed −> Screen 1
Screen 7
---------------------
Have you taken a new
blood glucose
measurement yet?
---------------------
ACTION −> RESULT
Press A −> Screen 11 (walk thru blood glucose measurement)
Press B −> Screen 12 (walk thru how to turn on glucometer)
Press C −> Screen 11
BP Measurement −> Screen 3
Gluc Measurement −> IF BP measurement already taken: Screen 9

Otherwise: Screen 4

3 minutes elapsed −> Screen 6
Screen 8
---------------------
Do you want to take
your blood pressure
before sending your
blood glucose?
---------------------
ACTION −> RESULT
Press A −> Screen 5
Press B −> Screen 5
Press C −> Screen 9 (sending data)
BP Measurement −> Screen 9
Gluc Measurement −> Screen 4
3 minutes elapsed −> Screen 9 (send data)
Screen 9
---------------------
Sending data to
the data center.
<STATUS = Dialing, Uploading, Downloading, or Hanging Up>
---------------------
ACTION −> RESULT
Press A −> no change
Press B −> no change
Press C −> Screen 13 (sure you want to cancel?) (aru—will this interrupt
the communication's protocal with the server?)
BP Measurement −> no change . . . let data be stored in monitor until next
interaction with HCM
Gluc Measurement −> no change . . . let data be stored in monitor until
next interaction with HCM
Successful data transfer −> Screen 14 (successful transfer)
Unsuccessful data transfer −> Screen 15 (data not received)
Screen 10
---------------------
Connect the correct
cable between the
home care monitor
and your device.
---------------------
ACTION −> RESULT
Press A −> Screen 16 (please consult your HCM manual)
Press B −> Previous Screen
Press C −> Previous Screen (aru—or should we ask if they just want
to send previous BP or Gluc measurements?)
BP Measurement −> IF BG measurement aleady taken: Screen 9
(send data)

Otherwise: Screen 3

Gluc Measurement −> IF BP measurement already taken: Screen 9
(Send data)

Otherwise: Screen 4

3 minutes elapsed −> Screen 6 (more time?)
Screen 11
---------------------
Please measure your
blood glucose level
with your glucometer
and press ‘Continue’
---------------------
ACTION −> RESULT
Press A −> Screen 17 (please consult your manual)
Press B −> Screen 12 (turn on glucometer)
Press C −> IF BP measurement already taken: Screen 18 (just send BP?)

Otherwise: Screen 2

BP Measurement −> Screen 3
Gluc Measurement −> IF BP measurement already taken: Screen 9
(Send data)

Otherwise: Screen 4

3 minutes elapsed −> Screen 6 (more time?)
Screen 12
---------------------
Slide the front
cover forward to
turn the glucometer
on.
---------------------
ACTION −> RESULT
Press A −> Screen 10 (connect the cable)
Press B −> Screen 10
Press C −> IF BP measurement already taken: Screen 18 (just
send BP?)

Otherwise: Screen 2

BP Measurement −> Screen 3
Gluc Measurement −> IF BP measurement already taken: Screen 9
(Send data)

Otherwise: Screen 4

3 minutes elapsed −> Screen 10
Screen 13
---------------------
Are you sure you
want to cancel?
---------------------
ACTION −> RESULT
Press A −> Screen 19 (explain consequences of dumping call)
Press B −> Screen 20 (call cancelled)
Press C −> Previous calling status screen (9 or 15) (wherever it got
left off)
BP Measurement −> no action . . . let data be stored in monitor until next
interaction with HCM
Glue Measurement −> no action . . . let data be stored in monitor until
next interaction with HCM
3 minutes elapsed −> Screen 9 (wherever it got left off)
Screen 14
---------------------
Your data has been
successfully sent to
the data center.
---------------------
ACTION −> RESULT
Press A −> Screen 21 (system info)
Press B −> Screen 2
Press C −> Screen 2
BP Measurement −> Screen 3 (BP received)
Gluc Measurement −> Screen 4 (glue received)
3 minutes elapsed −> Screen 1
Screen 15
---------------------
Data NOT received by
the data center.
Trying again.
<STATUS = Dialing, Uploading, Downloading, or Hanging Up>
---------------------
ACTION −> RESULT
Press A −> no change
Press B −> no change
Press C −> Screen 13 (sure you want to cancel?) (aru—will this
interrupt the communication's protocol with the server?)
BP Measurement −> no change . . . let data be stored in monitor until next
interaction with HCM (i.e.—interrupts disabled)
Gluc Measurement −> no change . . . let data be stored in monitor until
next interaction with HCM (i.e.—interrupts disabled)
Successful data transfer −> Screen 14 (successful transfer)
Unsuccessful data transfer −> If this was the second attempt, try one more
time: Screen 15

If this was the third attempt (or more) : Screen 16

(consult HCM manual)
Screen 16
---------------------
Please consult your
home care monitor
manual for further
help on the problem.
---------------------
ACTION −> RESULT
Press A −> No action
Press B −> Previous Screen
Press C −> Previous Screen
BP Measurement −> IF BG measurement aleady taken: Screen 9
(send data)

Otherwise: Screen 3 (BP received)

Gluc Measurement −> IF BP measurement already taken: Screen 9
(Send data)

Otherwise: Screen 4

3 minutes elapsed −> Screen 6 (more time)
Screen 17
---------------------
Please consult your
glucometer manual
from Bayer for
further help.
---------------------
ACTION −> RESULT
Press A −> No action
Press B −> Screen 11
Press C −> Screen 11
BP Measurement −> Screen 3 (BP received)
Gluc Measurement −> IF BP measurement already taken: Screen 9
(Send data)

Otherwise: Screen 4

3 minutes elapsed −> Screen 6 (more time)
Screen 18
---------------------
Do you want to take
your blood glucose
before sending your
blood pressure?
---------------------
ACTION −> RESULT
Press A −> Screen 17 (help with Gluc measurement)
Press B −> Screen 11 (pls take glue meas.)
Press C −> Screen 9 (send data)
BP Measurement −> Screen 3 (BP received)
Gluc Measurement −> Screen 9 (Send data)
3 minutes elapsed −> Screen 6 (more time)
Screen 19
---------------------
Your data will be
saved in your home
care monitor until
the next call.
---------------------
ACTION −> RESULT
Press A −> Screen 13
Press B −> Screen 13
Press C −> Screen 13
BP Measurement −> no action
Gluc Measurement −> no action
15 seconds −> Screen 13 (aru—how will this time affect the
communications protocol?)
Screen 20
---------------------
- Call Cancelled -
Your data will be
sent with next call.
---------------------
ACTION −> RESULT
Press A −> Screen 2
Press B −> Screen 2
Press C −> Screen 2
BP Measurement −> Screen 3
Gluc Measurement −> Screen 4
3 minutes −> Screen 1
Screen 21
---------------------
Unit ID:
Firmware Vers.:
Patient ID:
Waiting: packets
---------------------
ACTION −> RESULT
Press A −> Screen 22 (next sys info)
Press B −> Screen 22
Press C −> Screen 2 (ask for measurement)
BP Measurement −> Screen 3
Gluc Measurement −> Screen 4
3 minutes −> Screen 1
Screen 22
---------------------
Last call at:
Phone number:
---------------------
ACTION −> RESULT
Press A −> Screen 2 (ask for measurement)
Press B −> Screen 2
Press C −> Screen 2
BP Measurement −> Screen 3
Gluc Measurement −> Screen 4
3 minutes −> Screen 1
Screen 23
---------------------
Would you like to
take your blood
pressure measurement
now?
---------------------
ACTION −> RESULT
Press A −> Screen 5 (walk thru BP measurement)
Press B −> Screen 5
Press C −> Screen 24 (ask about gluc measurement)
BP Measurement −> Screen 3
Gluc Measurement −> Screen 4
3 minutes −> Screen 1
Screen 24
---------------------
Would you like to
send your blood
glucose measurement
now?
---------------------
ACTION −> RESULT
Press A −> Screen 11 (walk thru gluc measurement)
Press B −> Screen 11
Press C −> Screen 1 (since they already didn't want to measure their BP)
BP Measurement −> Screen 3
Gluc Measurement −> Screen 4
3 minutes −> Screen 1

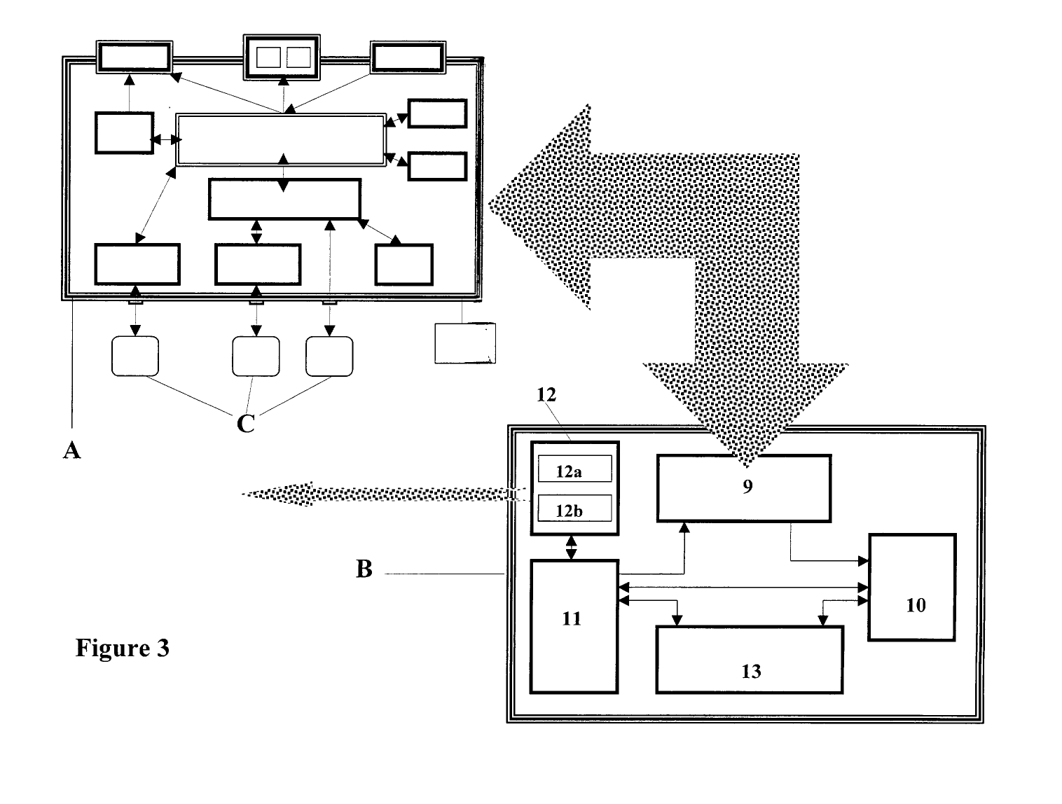

As shown in FIG. 3, information obtained from home unit A is transmitted to server B, where it is processed, and further capable of being transmitted to a remote location via transmission lines including but not limited to phone lines or internet connection for review, analysis and/or storage.

Server B:

Server B includes a network connection 9 that answers calls from home unit A and also sends information back to home unit A. Information received from unit A is transmitted to a physiological measurement database 10. The physiological measurement database 10 stores all of the patient's physiological measurements; stores physician set limits; sends alerts when measurements are outside of preset values; and if desired, accesses a questions database 11. Questions database 11 holds a collection of queries that are used to obtain supplemental information to the monitored measurements. These queries can be added, removed or modified by health care professionals from a remote location. The queries are capable of being triggered by a variety of monitored measurement responses and vary with the type of devices C utilized by the system. The questions database 11 is connected to a call back system 12 having a call-back modem 12a and an audio output 12b. The call back system 12 activates the questions database 11 so as to communicate with the user. The call back system 12 also acts to confirm receipt of information from unit A. Additionally, the call back system 12 assures that a physician or medical caregiver provides rapid communication with the patient when needed.

Responses to queries from the questions database 11 can alternatively be stored in the physiological measurements database 10.

The queries from measurements database 10 and questions database 11 are gathered onto a data display server 13. The server 13 allows medical personnel access to data in both the measurements database 10 and the questions database 11 and further allows the information in either database to be altered by physicians or medical caregivers. Alternatively, server 13 also allows patients and their families to view patient's data in the measurements database 10.

The information obtained via home unit A and the server B can then be transmitted to at least one remote location, such as a health care provider facility. In addition, the system S can also transmit pertinent user information to family members, and back to the user. Note also that the system S can utilize a plurality of servers B, if so required.

As stated above, the home unit A and server B of system S of the present invention provide an interactive apparatus that allows for rapid response between a user and a remote health-care provider, and/or family member.

What is claimed is:

1. A system for providing home based health care comprising a home unit, at least one server component and a plurality of measurement devices.

2. A system for providing home based health care as recited in claim 1, wherein said home unit is positioned remote to said server component, and further comprising a microprocessor connected to at least one memory component for storing data and operating instruction.

3. A system for providing home based health care as recited in claim 2, wherein said memory component is selected from a group comprising RAM, SRAM, Flash and EEPROM type devices.

4. A system for providing a home based health care as recited in claim 3, wherein said microprocessor is also connected to a real time clock, said real time clock constructed so as to track date, time and imprint a timestamp on incoming and outgoing data.

5. A system for providing home based health care as recited in claim 4, wherein said microprocessor is further connected to a multi-channel communications component for transmitting and receiving information from an external source.

6. A system for providing home based health care as recited in claim 5, wherein said component is selected from a group comprising wired and wireless transmission devices; said component further connected to a means for transmitting and receiving information via external computers.

7. A system for providing home based health care as recited in claim 6, wherein said microprocessor is further connected to a visual output;
said visual output further comprising a display screen, wherein said display screen is constructed so as to display a plurality of screens to the user, wherein said screens include query sets and information obtained from said user.

8. A system for providing home based health care as recited in claim 7, wherein said microprocessor is further connected to a user input system, said user input system constructed so as to allow the user to interact with said home unit.

9. A system for providing home based health care as recited in claim 8, and further comprising an analog to digital converter and a voltage level converter,
wherein said microprocessor is further connected to said analog to digital converter, said analog to digital converter constructed so as to operate analog type said measurements devices with said microprocessor; and
said microprocessor is further connected to said voltage level converter, said voltage level converter constructed so as to allow said measurement devices having varying voltages to operate with said microprocessor.

10. A system for providing home based health care as recited in claim 9 and further comprising a plurality of ports, wherein said ports are positioned on said home unit so as to allow said measurement devices to connect with said home unit.

11. A system for providing home based health care as recited in claim 10, and further comprising a modem, wherein said modem is housed within said server component so as to transmit and receive information from said home unit.

12. A system for providing home based health care as recited in claim 11, and further comprising a physiological measurement database, said database connected to said modem, wherein said database constructed so as to store all the user's physiological measurements, stores physician set limits, sends alerts when measurements are outside of preset values.

13. A system for providing home based health care as recited in claim 12, and further comprising a data display server, said server connected to said physiological measurement database, said data display server constructed so as to allow remote health care providers access to said user's measurements.

14. A system for providing home based health care as recited in claim 13, and further comprising a questions database, said database constructed so as to communicate with said means for transmitting and receiving information, said database further constructed so as to hold a collection of queries so as to obtain supplemental information from said measurement devices; and
said data display server further constructed so as to allow remote care providers access to said user's responses.

15. A system for providing home based health care as recited in claim 14, and further comprising call back system, wherein said call back system calls the user of said home unit.

16. A system for providing home based health care as recited in claim 15, wherein said call back system includes a modem and an audio output.

17. A home care unit comprising a microprocessor connected to a memory component for storing data and operational instructions.

18. A home care unit as recited in claim 17 and wherein said memory component is selected from a group comprising RAM, SRAM, Flash and EEPROM type devices.

19. A home care unit as recited in claim 18, wherein said microprocessor is also connected to a real time clock, said real time clock constructed so as to track date, time and imprint a time stamp on incoming and outgoing data.

20. A home care unit as recited in claim 19, wherein said microprocessor is further connected to a multi-channel communications component for transmitting and receiving information from an external source.

21. A home care unit as recited in claim 20, wherein said component is selected from a group comprising wired and wireless transmission devices; said component further connected to a modem component for transmitting and receiving information via external computers.

22. A home care unit as recited in claim 21 wherein said microprocessor is further connected to a visual output;
said visual output further comprising a display screen, wherein said display screen is constructed so as to display a plurality of screens to the user, wherein said screens include query sets and information obtained from said user.

23. A home care unit as recited in claim 22, wherein said microprocessor is further connected to a user input system, said user input system constructed so as to allow the user to interact with said home unit.

24. A home care unit as recited in claim 23, and further comprising an analog to digital converter and a voltage level converter,
wherein said microprocessor is further connected to said analog to digital converter, said analog to digital converter constructed so as to operate analog type said measurements devices with said microprocessor; and
said microprocessor is further connected to said voltage level converter, said voltage level converter constructed so as to allow said measurement devices having varying voltages to operate with said microprocessor.

25. A home care unit as recited in claim 24 and further comprising a plurality of ports, wherein said ports are positioned on said home unit so as to allow said measurement devices to connect with said home unit.

26. A system for providing home based health care comprising a home unit, at least one server component and a plurality of measurement devices.

27. A system for providing home based health care as recited in claim 26, and further comprising a call back system, wherein said call back system calls the user of said home unit.

28. A system for providing home based health care as recited in claim 27, wherein said call back system includes a modem and an audio output.

29. A system for providing home based health care comprising a home unit, at least one server component and a plurality of measurement devices.

30. A system for providing home based health care as recited in claim 29, and further comprising a call back system, wherein said call back system calls the user of said home unit.

31. A system for providing home based health care as recited in claim 30, wherein said call back system includes a modem and an audio output.

32. A system for providing home based health care as recited in claim 31, wherein said server further comprises a means for transmitting and receiving information and a data display server.

33. A system for providing home based health care as recited in claim 32, and further comprising a questions database, said database constructed so as to communicate with said means for transmitting and receiving information;
said database further constructed so as to hold a collection of queries so as to obtain supplemental information from said measurement devices; and
said data display server further constructed so as to allow remote care providers access to said user's responses.
